(19) United States
(12) Patent Application Publication
(10) Pub. No.: US 2024/0368491 A1
(43) Pub. Date: Nov. 7, 2024

(54) ADSORBENT AND PROCESS FOR METHANOL AND OXYGENATES SEPARATION

(71) Applicant: M Chemical Company, Inc., Los Angeles, CA (US)

(72) Inventors: Albert M. Tsybulevski, Louisville, KY (US); Eduardo Bolivar, The Woodlands, TX (US)

(73) Assignee: M Chemical Company, Inc., Los Angeles, CA (US)

(21) Appl. No.: 18/773,713

(22) Filed: Jul. 16, 2024

Related U.S. Application Data
(63) Continuation of application No. 17/453,885, filed on Nov. 8, 2021, now abandoned.
Application No. 17/453,885 is a continuation of application No. 16/110,921, filed on Aug. 23, 2018, now abandoned.

(51) Int. Cl. C10L 3/10; B01D 53/04; B01D 53/047; B01J 20/18

(52) U.S. Cl. CPC C10L 3/106; B01D 53/0462; B01D 53/047; B01J 20/18; C10L 3/101; B01D 2253/1085; B01D 2257/704; B01D 2257/80; B01D 2259/40028; C10L 2290/12; C10L 2290/542

(57) ABSTRACT

An adsorbent separates methanol and other alcohols from gas and liquid oxygenates and hydrocarbon streams with a low silica faujasite (LSX) in a mono-, bi, or tri-cation alkali and/or alkaline-earth metal forms. The LSX has silicon to aluminum ratio from about 0.9 to about 1.15 and an ion exchange degree for each alkali or alkaline-earth metal in the range of about 10 to about 99.9% equiv. The gas streams for treatment include natural gas, individual hydrocarbons, or vaporized alkyl esters of carboxylic acids, or methyl tert-alkyl ethers and their mixtures with hydrocarbons. The liquid streams include liquefied natural gas (LNG), liquefied petroleum gas (LPG), natural gas liquid (NGL), individual hydrocarbons C₃-C₅, and monomers, alkyl esters of carboxylic acids including methyl acetate, methyl, ethyl, butyl acrylates and methacrylate, methyl tert-alkyl ethers including methyl tert-butyl ether (MTBE) and methyl tert-amyl ether (TAME). The adsorbent is especially suited for temperature swing or pressure swing adsorption processes.

### FIELD OF THE INVENTION

The present invention relates to an adsorbent for separation and purification processes to remove methanol and other oxygenates from gas and liquid streams including natural and associated gases, individual hydrocarbons, natural gas liquid (NGL), liquefied petroleum gas (LPG), as well as the chemical synthetic products on methanol, ethanol, butanol basis such as methyl acetate, methyl, ethyl, butyl acrylates and methacrylate, methyl tertiary butyl (MTBE) and methyl tertiary amyl (TAME) ethers. In addition, the present invention relates to a process for methanol and oxygenates recovery and separation from liquid and gas streams.

### DESCRIPTION OF THE PRIOR ART

Methanol is conventionally used as a solvent and raw material in many commercially important processes. It is well known, for example, the use of methanol for natural gas processing, dehydration, carbon dioxide and hydrogen sulfide removal. Methanol injection into natural gas streams before any kind of cryogenic treatment is widely employed to avoid hydrocarbons and carbon dioxide hydrates formation.

Such valuable chemicals and intermediates as methyl acetate, methyl, ethyl and butyl acrylate, methyl methacrylate may usually be prepared by methanol esterification with adequate carboxylic acids or their derivatives: acetic, acrylic and methacrylic. The esterification products create an azeotrope predominantly containing the ester as a target product, water as a by-product, and unreacted methanol, carboxylic acids and their esters. As a result, there are few economically viable ways for manufacturing methyl-carboxylic acid esters having purity greater than 97%, particularly greater than 99% by weight.

In like manner, methyl tert-alkyl ethers MTBE and TAME, which are valuable solvents and gasoline octane boosters, are produced by catalytic condensation of methanol and branched olefins with a double bond on a tertiary carbon atom. In this case, an azeotropic blend: methanol-ether-water-hydrocarbon is obtained, which might be processed by means of methanol separation. Alternatively, methanol is concentrated in the unreacted unsaturated hydrocarbons so that its content varies from 0.1 to 2.5% v. Unreacted olefins need minimal or essentially no methanol traces for use in sulfuric or hydrofluoric acid alkylation units.

More importantly, present day biodiesel fuel production by esterification vegetable oils using methanol requires an essentially complete separation of the methanol from the product.

Many processes for methanol and oxygenates separation from the mentioned gas and liquid streams have been invented and commercially used. For instance, the use of multiphase fractional or extractive distillation is well known such as it is disclosed in European Patents Nos. 060,717 to Yeomans and 087870 to Cooper. Among other methods, the use of adsorbents for methanol and oxygenates separation can provide good results due to a high purification performance at relatively low capital and operational expenses.

U.S. Pat. No. 3,841,058 to Templeman and French Patent No. 2,779,059 to Jullian disclose the use of zeolite or activated carbon for methanol removal from natural gas. The main disadvantage of the proposed adsorbents consists of great deviation between dynamic adsorption capacities for moisture and methanol resulting methanol breakthrough prior the complete loading the adsorbent bed by water vapors. As a result, significant amounts of methanol stay unrecovered in the natural gas flow and leads to significant reagent losses. Simultaneously, a low concentration of methanol in the adsorbent regeneration liquid prevents its economical reclaiming. At the same time, methanol contaminates all products of gas processing including LNG, ethane, LPG and NGL thereby reducing their quality. To overcome such undesired results the Russian Patent No. 2,607,631 to Mnushkin teaches applying three layers of molecular sieves 3A, 4A or 5A and 10X (CaX). U.S. Pat. No. 8,147,588 to Dolan discloses an adsorbent for oxygenates removal from olefin streams which comprises a complex blend of zeolites X, Y, ZSM-5 and activated alumina impregnated by alkali metals. However, even such combined bed and complex adsorbent mixtures cannot improve methanol recovery by more than 15-20% over that generally achieved by the above-mentioned adsorption processes.

U.S. Pat. No. 6,984,765 to Reyes and China Patent No. 105,585,405 to Yongchou disclose the use of high silica zeolites AIPO-34, AIPO-18, chabazite and SAPO-34 for methanol removal from hydrocarbon flows. Enormous costs and very limited commercial availability make their use impractical for large scale applications such as hydrocarbon processing.

Several adsorption technologies are known and applied for methanol and oxygenate azeoptrope separations associated with methanol etherification and esterification products and include temperature swing adsorption (TSA), concentration swing adsorption (CSA) as well as pressure swing adsorption (PSA) processes. U.S. Pat. No. 4,748,281 to Whisenhunt discloses the use of a silica gel in a TSA process for methanol recovery from unreacted butane-butylene fraction exiting an MTBE synthesis reactor. U.S. Pat. No. 5,030,768 to Chen describes the use of molecular sieve 4A for CSA adsorption separation of primary alcohols C₁-C₈ from an azeotropic mixture of alcohol/ether/hydrocarbon/water. WO Patent No. 029,366 to Outlaw describes the use of molecular sieves 4A, 5A and 13X having a pore size range of 4-15 Å in a PSA process for methanol and water separation from vaporized methyl acetate. In more intricate processes such as simulated moving bed (SMB) technology, U.S. Pat. No. 8,658,845 to Oroscar suggests the use of a complex adsorbent comprising a fluorinated carbon and a modified silica gel for ethanol recovery from biofuel. US Patent Application No. 2005/0188607 to Lastella applies magnesium silicate to such separations.

The main disadvantage of the prior art adsorbents for methanol and oxygenates separation from liquid streams is a low selectivity of methanol adsorption relative to adsorption of other admixtures, specifically esters and ethers. An appreciable co-adsorption of the latter results in the need for a plurality of the adsorption vessels to produce the desired final product. Low alcohol adsorption values at its low partial pressure range significantly detracts from usage of the prior art adsorbents because the resulting products fail to reach purities of greater than 99.8%. This falls short of the purity required for the most of applications.

While the prior art adsorbents find usage in separating methanol and oxygenates from gas and liquid streams, additional adsorbents are sought that reduce or eliminate the disadvantages of the prior art.

### SUMMARY OF THE INVENTION

It has been discovered that an adsorbent constituting mono-, bi-, or tri-cation forms of a low-silica faujasite X (LSX) having a silicon to aluminum (Si/Al) ratio from about 0.9 to about 1.15 possess an extended adsorption capacity and selectivity for methanol and oxygenates recovery from gas and liquid streams providing the required purity of the separation products. A surprising discovery of the present invention is that the adsorption capability of mono-cation forms of LSX, on one hand, and bi- and tri-cation forms, on the other, are antipodal in the low and high methanol concentration fields. Thus, the present invention features an adsorbent for viable adsorption cycling processes for methanol and oxygenates separation from various gas and liquid streams wherein the adsorbent herein described can provide an improved separation of the complex mixtures and/or complete removal of undesired impurities from the resulting products. The mono-, bi-, or tri-cations may consist of alkali and/or alkaline-earth metal cations, preferably sodium, potassium, magnesium and calcium wherein an ion exchange degree for each said alkali or alkaline-earth metals varies from 10 to about 99.8% equivalent.

This invention includes adsorbents for methanol removal from moisturized natural gas streams and individual hydrocarbons. Typically, in such applications the low-silica faujasite contains cations of two alkali and/or alkaline-earth metals, and the ion exchange degree of each said metal cation usually varies in the range of 40-75% (equiv.).

The present invention also applies to the use of the adsorbent to achieve high purities in the removal of methanol, ethanol, butanol, carboxylic acids, esters, ethers, anhydrates, aldehydes, ketones, and/or peroxides from relatively pure hydrocarbon stream and their blends, including ethane, propane, monomers, liquified petroleum gas (LPG), natural gas liquid (NGL) and liquified natural gas (LNG.). When used in this manner (with process equipment well known to those skilled in the art) the adsorbent can provide a high purity of hydrocarbon product with a residual oxygenate content not exceeding 2 ppm. In such applications the low silica faujasite is in an exchanged form having mono-cations of alkali or alkaline-earth metals, preferably NaLSX, KLSX, CaLSX with an ion exchange degree of not less than 99% and residual content of other alkali and alkaline-earth metals not greater than 0.9% (equiv.).

The invention also features adsorbents which are particularly useful for adsorbing methanol and other alcohols, vaporized carboxylic acids and their alkyl esters separation in the production of methyl acetate, methyl-, ethyl-, butyl acrylates, and methyl methacrylate. These adsorbents according to the invention comprise and in most cases will consist essentially of bi-cation sodium-potassium or sodium-calcium exchanged form of the low-silica faujasite wherein the sodium ion exchange degree comprises 55-80% while potassium and calcium ion exchange degree does not exceed 45% (equiv.).

The subject adsorbent may separate methanol, vaporized carboxylic acids and their alkyl esters in methyl acetate, methyl-, ethyl-, butyl acrylates, and methyl methacrylate production using PSA technology. The preferred adsorbent composition characteristics of this adsorbent type is the low-silica faujasite in potassium ion exchanged form having the ion exchange degree of about 92 to about 96% (equiv.) and the cation contents of other alkali and alkaline-earth metals including sodium, lithium, calcium and magnesium from about 0 to about 8% (equiv.) each.

When the invention is applied to methanol and vaporized methyl tert-alkyl ethers separations in the process of methyl tert-butyl ester (MTBE) and methyl tert-amyl ester (TAME) production, the adsorbent composition typically consists of a low-silica faujasite containing predominantly cations of alkaline earth metals calcium or magnesium with ion exchange degree greater than 88% (equiv.).

Other highly suitable applications of the present invention include the use of the adsorbent in temperature and pressure swing adsorption processes and particularly where such processes are applied to methanol and oxygenates separation from gas and liquid streams.

Accordingly, in one aspect this invention discloses a commercially practical adsorbent for methanol and oxygenates separation providing purity of the treated gas and liquid streams greater than 99.9% w.

In a further aspect this invention provides a commercially practical adsorbent for use in separating gas and liquid streams containing alcohol at concentrations ranging from 250 ppm to 10-20% v.

A still further aspect of the invention discloses an adsorbent suitable for commercial use that can simultaneously provide a reliable and deep dehydration along with recovery of methanol and other alcohols from gas and liquid streams.

A yet further aspect of the invention discloses an adsorbent for gas and liquid streams separation that provides a methanol concentration in the adsorbent regeneration liquid that significantly reduces energy consumption for methanol reclaiming.

Another aspect of the invention provides an adsorbent having an enhanced adsorption capacity in the methanol recovery at low concentrations and partial pressures of methanol, particularly in a presence of strong polar substances such as water, esters, ethers, carboxylic acids, anhydrates, aldehydes, ketones, etc.

A still further aspect of the invention to disclose an adsorbent suitable for commercially practical use in TSA and PSA processes for methanol and oxygenates separation from gas and liquid streams.

This invention provides many advantages some of which include: more complete methanol recovery resulting purified streams with methanol concentrations below 1-100 ppm or with the streams purity of greater than 99.99%; high efficacy in simultaneously dehydrating and purifying gas and liquid streams; a high selectivity for alcohol adsorption in presence of esters, ethers, carboxylic acids etc. thereby providing multifold increases in the methanol capacity of adsorbent beds that also substantially decreases operational costs of oxygenates separations; a significantly heightened ratio of the adsorption capacities for methanol and water that increases methanol concentrations in the regeneration liquid and provides substantial energy saving in methanol reclaiming and recycling; broad application to varying gas concentrations in gas and liquid feedstocks ranging from tens of ppm to percentage levels; enhanced adsorption capacity at low oxygenates concentrations and partial pressures; and methanol recovery in the presence of competitive adsorbates such as strong polar substances including water, carboxylic acids, anhydrates, ethers, esters, etc.

### BRIEF DESCRIPTION OF THE DRAWINGS

FIGS. 1 and 2 present the equilibrium methanol adsorption values over binary sodium-potassium cation exchanged forms of LSX, when ion exchange degree for each cation varies from 0 to 100% inversely along the x-coordinate. It means that “0” on x-coordinate corresponds to a LSX with 100% potassium ion exchange and “100” corresponds to the absence of potassium ion exchange in the LSX and “0” on the x—corresponds to the absence of sodium exchange and “100” corresponds to 100% sodium exchanged LSX. FIG. 1 presents data for a methanol concentration in the n-pentane solution of 2.2% and FIG. 2 presents data for a low methanol concentration range of 100 ppm.

### DETAILED DESCRIPTION OF THE INVENTION

The present invention provides an efficient and reliable adsorbent for methanol and oxygenates separations from liquid and gas streams featuring a temperature swing adsorption (TSA), concentration swing adsorption (CSA), as well as pressure swing adsorption (PSA) processes. The adsorbent of the invention is useful in a broad range of methanol concentration and partial pressures from 20 ppmv up to 2-5% v. The other feature that distinguishes the adsorbent of the invention consists of its superior performance at separation of gas and liquid streams that significantly contaminate a large amount of high polarity substances, such as water, esters, ethers, carboxylic acids, etc. and limits their use in large scale operations.

In accordance with that previously described discovery, the adsorbent, according to the invention, constitutes a low-silica faujasite (LSX) having a silicon to aluminum ratio from about 0.9 to about 1.15 and having in its composition one, two or three cations of alkali or alkaline-earth metals, preferably selected from the group of sodium, potassium, calcium or magnesium. The ion exchange degree for each said alkali or alkaline-earth metals varies from 10 to about 99.8% equivalent.

Bi-cation sodium-potassium forms of low-silica faujasite may be obtained by direct synthesis from the corresponding silicates, aluminates and hydroxides, as described for example in Kůhl “Crystallization of Low-Silica Faujasite”, Zeolites, vol. 7, p. 451, 1987. Mono- and tri-cation forms of low-silica faujasite, which are useful in the preferred embodiment of the invention, can be obtained by conventional ion exchange procedure with corresponding alkali or alkaline-earth metal salts such as chlorides, nitrates, sulfates, acetates, etc. For instance, mono-cation NaLSX and KLSX forms of the adsorbent can be prepared by ion exchange of the original bi-cation NaKLSX form with sodium and potassium chlorides respectively; treating original molecular LSX sieve by calcium chloride or calcium nitrate solutions will form bi-cation sodium-calcium form NaCaLSX; and treating molecular LSX sieve with magnesium salts solutions and so forth will form MgNaLSX or MgKLSX.

It is well known that for standard faujasite X with a silicon to aluminum ratio 1.20-1.60, a replacement of original sodium cations in faujasite framework causes a decrease of its adsorption capacity for methanol.

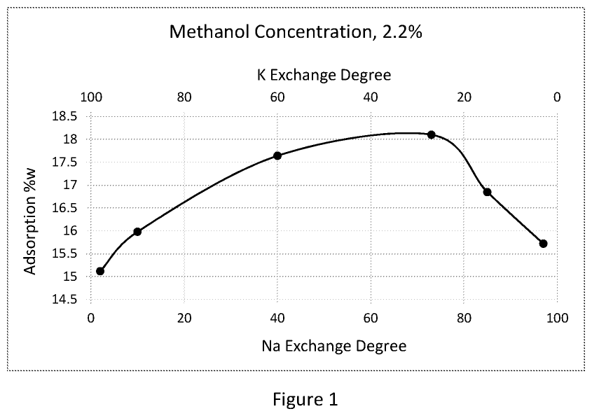

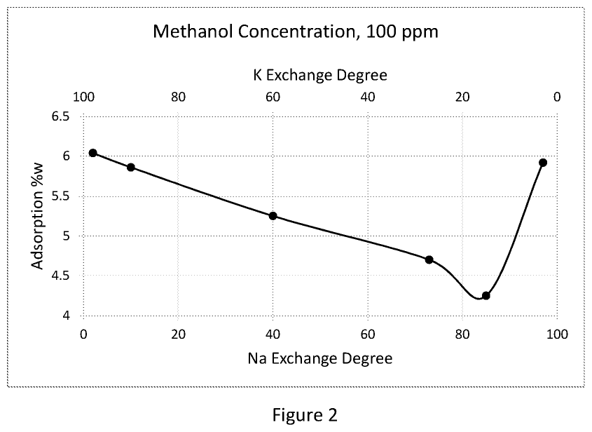

FIGS. 1 and 2 illustrate the surprising discovery that adsorption capability of mono-cation forms of LSX, on one hand, and bi- and tri-cation forms, on the other, are antipodal in the low and high methanol concentration fields. These data show that bi-cation exchanged forms of LSX are most suitable for methanol recovery from its high concentrated mixtures, while mono-cation exchanged forms with Na and K ion exchange degree higher 99.2% are greatly preferable in the low methanol concentration range.

Similar results were obtained for all other alkali and alkaline-earth cation exchanged forms of LSX, including Ca and Mg, i.e. bi-cation NaK—, NaCa—, KCa, CaMg— and so forth. In such a manner, the bi-cation forms of molecular sieve LSX are preferential for methanol adsorption in the high adsorbate concentration range >750 ppm, while the corresponding mono-cation forms, such as NaLSX, KLSX, CaLSX, MgLSX much more applicable for methanol recovery in low concentration range of 10-500 ppm. It was also found that the same holds true for adsorption of higher molecular weight methanol homologs such as ethanol, iso-propanol and butanol, particularly at the conditions of competitive adsorption of strong polar substances, such as water, carboxylic acids and their derivatives.

The discovered principles of methanol and oxygenates adsorption over cation exchanged zeolite LSX allow formulating the scope and use of the present invention. The various adsorbents within the scope of this invention prove suitable for such processes as TSA process for natural and associated gas dehydration and purification. The TSA process will include adsorption and regeneration steps in the following description of representative steps.

In the adsorption stage, a natural gas stream saturated with water vapors, which contains methanol in the amount of 750 ppm or above, passed through a single or several adsorption vessels loaded with a bi- or tri-cation form of low-silica faujasite. Adsorption pressure may vary from about 1 to about 80 bars, temperature from about −15 to about +65 C and gas flow linear velocity from about 0.03 to about 0.35 m/sec. The adsorbent selectively picks up moisture and methanol vapors whereas other components pass through the adsorbent bed without changing natural gas composition.

Meanwhile, a mass transfer zone (MTZ) for each adsorbate is formed as natural gas feed first contacts a newly regenerated adsorbent bed. As the natural gas stream passes through the bed an MTZ (I) for methanol moves toward the outlet of the adsorbent bed in front of an MTZ(II) for the moisture adsorption. When MTZ (1) reaches the end of the adsorbent bed, a concentration of methanol in the purifying flow begins rising. Then the adsorbent bed loaded by water and methanol vapors switches to a regeneration step and the process directs the natural gas feed to newly regenerated adsorbent bed. The adsorption step typically continues until moisture breakthrough, so that the dynamic methanol capacity of the adsorbent defines methanol losses as its concentration in the dehydrated gas flow while its concentration in the regeneration liquid in turn determines the economics of the methanol reclaiming and recycle into the process.

In the regeneration stage purified natural gas or any other gas devoid of methanol, for example hydrocarbons, nitrogen, hydrogen or carbon dioxide passes as single gas or a combination of gases at an elevated temperature through the adsorbent bed now loaded with methanol and water vapors from a preceding adsorption step. The ratio of regeneration gas volume to the volume of purified gas usually varies from about 1:4 to about 1:20. Thus the invention has the advantage of giving essentially complete with very low amounts of regeneration gas. Regeneration temperature usually ranges from about 120 to about 280° C., and pressure from about 0.05 to about 80 bars. High temperatures of the adsorbent bed and regeneration gas purity carry out the desorption of methanol and moisture from adsorbent. Preferably each regeneration cycle restores the adsorbent bed to original adsorbate capacity. Each regeneration cycle also saturates the regeneration gas with the desorbed impurities that exit the adsorption vessel along with the regeneration gas.

The regeneration effluent is chilled, methanol and moisture are condensed, separated from gas flow, and subsequently transferred to a distillation column for methanol reclaiming. The regenerated adsorbent bed is cooled to the adsorption temperature, whereupon it is ready for the next purification process cycle.

In another preferred embodiment of the invention, a PSA process is applied to methanol recovery and separations of vaporized moisturized methanol and other mixtures that can include alcohols, esters and/or ethers with or without hydrocarbons and carboxylic acids. The following steps typify the operation of the preferred PSA process for methanol and oxygenates separation.

During the adsorption step, the feed enters an adsorber containing a mono-cation potassium exchanged form of LSX faujasite with a potassium exchange degree of about 92% equiv. or above and a content of other alkali or alkaline-earth metals not exceeding 8% equiv. Methanol and other impurity vapors are adsorbed at temperatures from about 25 to about 100° C., pressure from about 1.3 to about 120 bars, and feed flow linear velocity from about 0.06 to about 0.35 m/sec. Adsorption of impurities yields purified product comprising pure ether and/or ester products that exit the adsorber with a residual methanol content of less than 0.01% v. and a moisture content below 10 ppmv. The purified product can be directed to an efficient distillation or for further synthesis. Adsorption times can vary from about 5 min to about 90 min after which the adsorber undergoes depressurization.

Depressurization of the adsorption vessel pressure decreased to its lowest pressure by releasing retained gas counter-currently to gas flow direction during adsorption. In most cases the depressurized adsorbent bed is partially regenerated by full release of methanol, ethers or esters that remained in the adsorbent bed after adsorption step completion. This flow can be directed to a supplemental adsorption vessel to decrease the product losses.

Usually a purge step follows depressurization to completely or essentially completely remove remaining impurities from the adsorbent bed by using a minor part of the purified product that passes through the adsorbent bed.

A minor part of the purified product is used for re-pressurizing the adsorbent bed to the pressure level of the adsorption step thereby readying the adsorption bed for the next purification cycle.

The main advantage of the process according to the present invention consists of enhanced purity of the process products that in turn allows avoiding additional separation steps and cutting down the capital and operational costs for the separations.

Various embodiments of the invention are further illustrated by the following specific examples. It is understood that these examples are illustrative and not intended to provide any limitations on the invention.

The term about when used herein means a variation of 5% from the given value.

### Examples 1 to 4 (Sample Preparation According to the Invention)

Beaded sodium—potassium LSX molecular sieve having Si/Al ratio of 1, a Na⁺ ion exchange degree of 76% and a K⁺ ion exchange degree of 23% equiv. was used as an Example 1 sample and as an initial material for additional sample preparation.

To increase Na content up to 85% equiv., in Example 2, 300 g of the initial material was treated at ambient temperature by contacting the material with 3 liters of 1.5 N solution of sodium chloride over 4 hours. The material was washed with deionized water (DIW) to remove excess of chloride ions, dried at 110° and calcined at 250° C.

In Example 3, 200 g of the NaKLSX adsorbent of the sample of Example 2 received treatment with 1 L of 2.5 N NaCl solution to raise its ion exchange degree to 97%.

In Example 4, 100 g of the material of Example 3 was treated at 80° C. with 1 L of 3.5 N solution of sodium chloride and then dried and calcined to obtain a mono-cation NaLSX sample.

Following the washing, drying and calcining the obtained samples were analyzed with the use of Atomic Absorption Spectroscopy (AAS) resulting in the following cation compositions of the samples:
Example 1: Na⁺-76%, K⁺-23%, Ca²⁺-1% (equiv.);
Example 2: Na⁺-84%, K⁺-15%, Ca²⁺-1% (equiv.);
Example 3: Na⁺-97%, K⁺-3%, Ca²⁺-0% (equiv.); and,
Example 4: Na⁺-99.7%, K⁺-0.3%.

### Examples 5 to 8 (Preparation of Samples According to the Invention.)

In Example 5 a sample with increased K⁺ cation content was prepared from the Sample of Example 1 by its treatment with a 1 N solution of KCl at ambient temperature followed by repetition of the sample washing, drying and calcining procedures of Example 2.

Examples 6 to 8 produced samples having an elevated potassium cation content obtained by treatment of the sample of Example 5 with a 2N KCl solution at 70° C. (Example 6), a 3N KCl solution at 85° C. (Example 7) and a 4.5 N KCl solution at 90° C. (Example 8).

AAS analysis of the samples showed the following cation presence in the adsorbent compositions:
Example 5: K⁺-60.5%, Na⁺-39.0%, Ca²⁺-0.5% (equiv.);
Example 6: K⁺-90.8%, Na⁺-9.0%, Ca²⁺-0.2% (equiv.);
Example 7: K⁺-98.2%, Na⁺-1.8%, Ca²⁺-0% (equiv.); and,
Example 8: K⁺-99.2%, Na⁺-0.8%.

### Examples 9 to 13 (Samples Preparation According to the Invention.)

A tri-cation CaNaKLSX sample was obtained for Example 9 by ion exchanging the original NaKLSX adsorbent of Example 1 with 1N solution of calcium chloride.

In Examples 10 and 11 bi-cation CaNaLSX samples were prepared by treatment of NaKLSX adsorbent of Example 3 with 1 and 2.2 N solutions of CaCl₂ respectively.

The bi-cation CaKLSX sample of Example 12 was prepared by ion exchange of the KLSX adsorbent of Example 7 with a 1N solution of calcium chloride.

The mono-cation CaLSF sample of Example 13 was obtained by consecutive treatments of the adsorbent of Example 3 with four treatments. The first three treatments were with 1.0, 2.2, 3.0 N solutions of CaCl₂) at ambient temperature followed by treatment with a 5.6 N solution at 90° C.

According to the analysis, the samples have the following cation composition:
Example 9: Ca²⁺-63.4%, Na⁺-24.9%, K⁺-11.7% (equiv.);
Example 10: Ca²⁺-32.6%, Na⁺-67.2%, K⁺-0.2% (equiv.);
Example 11: Ca²⁺-80.3%, Na⁺-19.6%, K⁺-0.1% (equiv.);
Example 12: Ca²⁺-78%. 0, K⁺-26.7%, Na⁺-0.3% (equiv.); and,
Example 13: Ca²⁺-98.6%, Na⁺-1.4%, K⁺-0.0% (equiv.).

### Examples 14 and 15 (Samples Preparation According to the Invention)

A magnesium-containing form MgNaLSX was prepared for Example 14 using the NaKLSX sample of Example 3 and an MgCaLSX was prepared for Example 15 using the CaNaLSX sample of Example 11 by treatment of the corresponding samples with a 1N solution of magnesium chloride.

The adsorbents had the following cation content:
Example 14: Mg⁺-50.5%, Na⁺-48.8%, K⁺-0.7% (equiv.); and,
Example 15: Mg⁺-60.2%, Ca²⁺-38.0′%, Na⁺-1.8% (equiv.)

### Example 16 (Equilibrium Methanol Adsorption Test)

Methanol adsorption was measured using the following methodology. A portion of the adsorbent was placed in a glass container with 100-250 ml of the stock solution. Stock solutions of methanol in n-pentane with concentration in the range of 100-1000 ppm were prepared employing Hamilton micro syringes and a measuring flask dilution method. The volume ratio solution/portion was taken up every time so that the difference between initial and equilibrium methanol concentration in the solution would not exceed 20% of the initial value. The mixture was maintained at ambient temperature for 2-3 days with intermittent shaking until the concentration of the contaminant in the solution reached the constant value.

Analysis of the stock and research solutions were carried out by means of gas chromatograph with a flame ionization detector and 30 m capillary column with a DB-WAX stationary phase. The results for measuring the adsorption capacities of the mono-, bi- and tri-cation LSX samples of the Examples 1 to 15 alongside conventional methanol adsorbents, i.e. molecular sieves 4A, 5A, 13X and silica gel are presented in Table 1.

It is clear from Table 1 data that alkali and alkaline-earth mono-, bi- and tri-cation exchanged LSX forms according to the present invention appreciably outdo all known methanol adsorbents including molecular sieves 4A, 5A, 13X and silica gel over the full range of methanol concentrations. Table 1 reveals an unusual peculiarity of adsorbent composition of this invention by the completely different behavior of mono-, bi- and tri-cation exchanged forms of the adsorbents at low, medium and high methanol concentrations in solution. The mono-cation NaLSX, KLSX and CaLSX forms of Examples 4, 8 and 13 exceed bi- and tri-cation LSX forms for methanol adsorption from low concentrated solutions below 300-350 ppm, while bi- and tri-cation exchanged LSX adsorbents of Examples 1, 2, 5, 9, 10, 14 and 15 manifest undisputable improved performance in medium and high methanol concentration range. This effect is obviously demonstrated by FIGS. 1 and 2 for sodium and potassium exchanged forms. In the high range of methanol concentration, i.e. a methanol concentration of 2.2% v., the bi-cation NaK-exchanged forms with ion exchange degrees 40-75% show the maximum adsorption values essentially exceeding mono-cation Na— and K-forms. On the contrary, as it follows from FIG. 2, in the low methanol concentration range of 100 ppm, mono-cation Na and K forms significantly surpass bi-cation forms methanol adsorption capability.

Accordingly, a preferential application of mono-cation adsorbents of the present invention is in deep purification processes, when high purity of the products below 2 ppm is required, while bi- and tri-cation LSX forms are highly suitable for bulk methanol separations from complex mixtures. It is also seen that the content of other cations in mono-cation exchanged adsorbents according to the present invention should not exceed 1,5%, and preferably will not exceed 0.8% equiv. At the same time, the degree of ion exchange of any alkali or alkaline-earth cations in the bi- and tri-cation adsorbents shouldn't fall below 60% equiv.

TABLE 1

| | Adsorption Capacity, % w. | | | | | | | |
|---|---|---|---|---|---|---|---|---|
| | Methanol Concentration, ppm | | | | | | | |
| Adsorbent | 50 | 100 | 200 | 300 | 400 | 500 | 750 | 1000 |
| NaKLSX-76 (Example 1) | 4.11 | 4.70 | 6.44 | 8.17 | 11.71 | 15.95 | 18.10 | 19.60 |
| KNaLSX-60 (Example 5) | 4.08 | 5.25 | 6.80 | 8.60 | 11.73 | 14.89 | 17.64 | 19.43 |
| CaNaLSF-80 (Example 11) | 4.04 | 5.07 | 6.95 | — | 12.01 | 16.05 | 18.33 | 19.70 |
| CaNaKLSX-63 (Example 9) | 4.18 | 5.39 | — | 8.18 | 12.10 | 15.70 | 17.68 | 18.96 |
| MgNaLSX-48 (Example 14) | 3.98 | 4.96 | 6.35 | — | 11.75 | 15.90 | — | 19.15 |
| NaLSX-97 (Example 3) | 4.98 | 6.05 | 7.42 | 9.05 | 12.16 | 16.05 | 16.72 | 18.35 |
| NaLSX-99.7 (Example 4) | 5.14 | 6.18 | 7.70 | 8.85 | 11.02 | 13.98 | 15.88 | 17.20 |
| KLSX-91 (Example 6) | 4.85 | 5.96 | 7.21 | — | 11.94 | 13.22 | 15.99 | 16.53 |
| KLSX-98 (Example 7) | 4.97 | 6.04 | 7.27 | 8.77 | — | 12.69 | 15.12 | 16.07 |
| CaLSX-99 (Example 13) | 4.76 | 5.47 | 6.98 | — | 11.10 | 13.60 | 15.08 | 15.90 |
| 4A (Dryamax 4A) | — | 2.78 | 4.35 | 5.19 | 7.15 | 8.11 | — | — |
| 5A (Dryamax 5A) | 1.60 | 2.15 | 3.85 | 5.35 | 7.48 | 8.46 | — | 10.31 |
| 13X (Dryamax 13X) | 2.19 | 4.11 | 5.22 | 6.51 | 8.57 | 10.28 | 12.82 | 14.13 |
| Silica Gel (Dryamax HC-5) | — | 4.63 | 5.80 | 7.10 | 10.02 | 12.00 | 14.06 | 15.98 |

### Example 17. (Natural Gas Dehydration and Purification Test)

The adsorbents of Examples 1, 5, 8 and 9 that represent the present invention were tested against the adsorbents of the prior art in a process for the simultaneous dehydration and methanol removal from natural gas using a pilot plant having an adsorbent vessel of 1 L volume and operating with gas temperature of 25° C., a pressure of 40 bar, a linear velocity of 0.15 m/sec, a relative humidity of 100%, and a methanol concentration that varied from 250 ppm up to 2.2% w. The dynamic capacity of the adsorbents for methanol was determined before moisture breakthrough dew point of −70° C. and before a methanol breakthrough of 20 ppm.

Table 2 presents the test results and clearly illustrates the advantages of the adsorbents of the present invention.

TABLE 2

| | Dynamic Capacity for Methanol, | | | | |
|---|---|---|---|---|---|
| | % w. | | | | |
| | To CH₃OH | | To Moisture | | |
| | breakthrough | | Dew Point | | |
| | of 20 ppm | | of −70° C. | | |
| | Methanol Initial Concentration, | | | | CH₃OH Content |
| | % w. | | | | In Regeneration |
| Adsorbent | 0.0375 | 2.20 | 0.0375 | 2.20 | Liquid, % w. |
| Example 1 | 4.15 | 14.20 | 3.12 | 11.90 | 42 |
| (NaKLSX-76) | | | | | |
| Example 5 | 4.08 | 13.50 | 2.98 | 12.06 | 40 |
| KNaLSX-60 | | | | | |
| Example 8 | 5.12 | 10.25 | 2.35 | 10.7 | 28 |
| (KLSX-99) | | | | | |
| Example 9 | 4.00 | 14.34 | 3.17 | 12.00 | 43 |
| (CaNaKLSX-63) | | | | | |
| 5A | 3.36 | 10.80 | 1.80 | 4.64 | 13 |
| 13X | 3.82 | 11.70 | 1.68 | 5.20 | 12 |
| Silica Gel | 1.21 | 9.46 | 0.86 | 3.90 | 8 |

Table 2 shows that although dynamic characteristics of all tested adsorbents are comparable when the gas dehydration process is interrupted after methanol breakthrough. These adsorption techniques, as verified by the experimental data, fail in commercial practicality due to the very low effectiveness of the adsorbents capacity for use in moisture removal, i.e. the adsorbents loading by water vapors decreases by 2-3 times. At the same time, the tests results demonstrate a completely reverse behavior of the prior art adsorbents and the adsorbents of the present invention at real conditions of natural gas dehydration processes that is typically conducted to reach the product gas dew point of −70 to −80° C. In such cases, methanol take-off from gas flow by the adsorbents of Examples 1, 5 and 9 is surprisingly and advantageously increased by 1.5-2 times. Therefore, the higher inlet methanol content of most natural gas makes the adsorbents of this invention significantly advantageous over the traditional ones.

The high methanol retention by the adsorbents of the present invention at conditions for displacing adsorption of water vapors clearly establishes a sharp reduction of the methanol losses. The concentration of methanol in the product gas, even at high initial contents such as 2.2% v., does not exceed 120 ppm through to the end of the gas dehydration cycle and provides a 10-fold decrease relative to the usage of the best-known 5A and 13X. Consequently, this leads to the significant 2-3 times increase of methanol content in the regeneration liquid and in turn to the substantial lowering of capital and operational expenses in the important step of reagent reclaiming.

The test results also show an essential advantage of bi- and tri-cation exchanged alkali and alkaline-earth metal LSX adsorbents of Examples 1, 5 and 9 over the mono-cation adsorbent of Example 8 in the process of simultaneous dehydration and methanol recovery. For such operations, the total content of one of the applied alkali or alkaline-earth metals has to range from about 40 to about 70% equiv.

### Example 18. (Methanol and Oxygenates Separations from Liquid Streams Test)

Performance of the adsorbents of the present invention of Examples 1 and 4 in the process of methanol recovery from hydrocarbon and oxygenate liquid streams was compared with the 13X molecular sieves of WO Patent No. 029,366 to Outlaw and the silica gel of U.S. Pat. No. 4,748,281 to Whisenhunt. These adsorbents were tested for methanol separation from its mixture with n-pentane, methyl acetate (MeAc) and methyl methacrylate (MMA) employing a tube adsorber. The bed volume was 80 cm³, temperature—25° C., liquid stream flow rate—1 L/min or LHSV=12.5 h⁻¹. The effluent samples at the adsorber discharge end were taken every 5-10 min and analyzed by means of a chromatograph as described in Example 16. Table 3 contains the data for the resulted stream purity and methanol dynamic capacity found for the various adsorbents.

The data shows that the bi-cation NaKLSX adsorbent of Example 1 does not reveal any advantages over the prior art adsorbents and is inferior to silica gel at the conditions of high methanol content in the feed and the essential absence of other polar substances. These are reasonable results because silica gel has at least 2 times higher meso- and macro-porosity than molecular sieves usually do. It is well known that meso- and micropores volume play a decisive role in liquid phase physical adsorption at a high concentration of adsorbates.

What was surprisingly discovered is the superiority of the mono-cation adsorbent of Example 4 over bi-cation forms of LSX and prior art adsorbents. The adsorbent of example 4 demonstrates much greater effectiveness in methanol recovery and obtaining high purity of the products that is unattainable by any other known adsorbents. This is particularly indicative at carboxylic esters separation, when a polar solvent partially or completely displaces methanol from a sorption volume.

Thus, the mono-cation exchanged LSX adsorbents can provide 99.99% purity of individual hydrocarbons and carboxylic acid esters and at the same time demonstrate 4.5-7.5 greater adsorption capacity for methanol removal. Accordingly, the adsorbents of the present invention require substantially lower bed volume and lower capital investments for the process commercialization. The adsorbent for fine purification of individual hydrocarbons and carboxylic acid esters should have an alkali or alkaline metal ion exchange degree greater than 99% and content of other cations lower than 0.9% equiv.

TABLE 3

| | Adsorbents | | | |
|---|---|---|---|---|
| Performance | Present Invention | | WO 029,366 | U.S. Pat. No. 4,748,281 |
| Characteristics | Example 1 | Example 4 | 13X | Silica Gel |
| | n-Pentane | | | |
| Methanol Content: | | | | |
| Inlet, % v. | 0.63 | 0.63 | 0.63 | 0.63 |
| Outlet, ppm | 100 | 2.0 | 100 | 100 |
| Dynamic capacity, %, w. | 25.9 | 20.5 | 25.4 | 36.1 |
| | Methyl Acetate | | | |
| Methanol Content: | | | | |
| Inlet, % v. | 0.90 | 0.90 | 0.90 | 0.90 |
| Outlet, ppm | 100 | 5.0 | 280 | 850 |
| Dynamic capacity, %, w. | 19.38 | 17.35 | 4.30 | 2.57 |
| | Methyl Methacrylate | | | |
| Methanol Content: | | | | |
| Inlet, % v. | 0.55 | 0.55 | 0.55 | 0.55 |
| Outlet, ppm | 100 | 6.0 | 370 | 505 |
| Dynamic capacity, %, w. | 12.03 | 10.20 | 9.30 | 3.28 |

### Example 19. (Vaporized Methyl Acetate and Ethyl Acrylate Purification and Dehydration Test.)

The adsorption unit and operating procedure of Example 17 were applied for alcohols and water recovery from vaporized methyl acetate and ethyl acrylate streams at process conditions that are representative of a PSA process. Alcohols and water vapor dosing into a vaporized ester stream were carried out by saturation of nitrogen flow in the separate bubblers filled with alcohols and water respectively. The trial series had the following compositions feed:
a) MeAc-82.2; MeOH-2.2; H₂O-0.5; N₂-15.1% v.
b) EtAcr-85.8; EtOH-2.2; H₂O-0.6; N₂-11.4% v.

The adsorbents of Examples 1, 10 and 14 were tested alongside molecular sieves 4A, 5A, 13X and silica gel of the prior art at an adsorption temperature of 55° C., a pressure of 1.3 bar, and a feed flow linear velocity of 0.1 m/sec. To provide a 99.99% product purity, alcohols concentration in the outlet stream was 100 ppm or below for all trials. The test results are given in Table 4.

TABLE 4

| | Dynamic Adsorption | | |
|---|---|---|---|
| | Capacity, % w. | | |
| Adsorbent | MeOH | EtOH | H₂O |
| Example 1 | 12.60 | 11.48 | 1.62 |
| (NaKLSX-77) | | | |
| Example 10 | 11.90 | 12.19 | 1.54 |
| (NaCaLSX-67) | | | |
| Example 14 | 10.03 | 8.76 | 1.50 |
| (NaMgLSX-50) | | | |
| 4A | 7.24 | — | — |
| 5A | 9.35 | — | 1.43 |
| 13X | 9.83 | 8.66 | 1.56 |
| Silica Gel | 1.25 | 2.20 | 0.98 |

The test results in Table 4 confirm the superiority of the present invention's adsorbents over the prior art adsorbents. Dynamic capacity of the bi-cation LSX adsorbent bed for alcohols is ˜30% higher than the best that the adsorbents of the prior art can achieve in processes for methyl acetate and ethyl acrylate separation. Although water capacity before alcohols breakthrough was practically on the same level for all tested adsorbents, the present invention provides an approximately 40% increase of the dynamic capacity of the adsorbent bed of this invention in processes for carboxylic acid esters simultaneous dehydration and separation.

Thus, the most effective adsorbents of the present invention for the separation of alcohols and corresponding esters from carboxylic acids are bi-cation sodium-potassium and sodium-calcium LSX zeolite, wherein sodium ion exchange degree comprises 55-80% while potassium and calcium ion exchange degree does not exceed 45% (equiv.). At the same time, performance comparison of the Example 1 adsorbent with those of Examples 10 and 14 shows that sodium cation content in the adsorbent should not be lower 50% (equiv.).

### Example 20. (Liquid Phase Methyl Acetate and MTBE Dehydration and Separation Test.)

The adsorbents of the present invention were tested against the prior art adsorbents in methyl acetate and methyl tert-butyl ether (MTBE) dehydration and separation by use of the static methodology of Example 16. The liquid feed compositions were:
a) MeOH-0.5; MeAc-99; H₂O-0.5% w.
b) MeOH-0.7; MTBE-98.8; H₂O-0.5% w.

Liquid volume/adsorbent volume ratio was 40:1. Water content in the dried liquid samples was determined by reactive gas chromatography method through the steps of injecting the sample into a calcium carbide cartridge in a front of GC column to provide the following determination of resulting acetylene. The obtained adsorption capacity values for methanol and water are recorded in Table 5.

TABLE 5

| | | | MeOH |
|---|---|---|---|
| | | | Content in |
| | Adsorption | | Regeneration |
| | Capacity, % w. | | Liquid, |
| Adsorbent | MeOH | H₂O | % w. |

Methyl Acetate Separation

| | | | |
|---|---|---|---|
| Example 2 (NaKLSX-84) | 5.90 | 19.06 | 22 |
| Example 5 (KNaLSX-60) | 6.85 | 21.20 | 26 |
| Example 10 (NaCaLSX-67) | 5.10 | 18.07 | 22 |
| 13X | 1.12 | 23.45 | 4.5 |
| Silica Gel | 1.71 | 28.17 | 5.9 |

Methyl Tert-Butyl Ether Separation

| | | | |
|---|---|---|---|
| Example 1 (NaKLSX-77) | 4.17 | 20.50 | 18 |
| Example 9 (CaNaKLSX-63) | 5.72 | 17.95 | 24 |
| Example 12 (CaKLSX-78) | 3.78 | 17.23 | 18 |
| Example 15 (MgCaLSX-60) | 5.14 | 16.90 | 25 |
| 13X | 0.98 | 22.00 | 4.3 |
| Silica Gel | 1.34 | 29.70 | 5.0 |

The results of Table 5 demonstrate the significant advantages of the present invention over the prior art. Comparison of the data of Tables 3 and 5 shows that the addition of water to methyl acetate and methanol mixture causes a significant decrease of the adsorbent capacity for methanol. However, the adsorbents of the present invention preserve methanol adsorption capacity on a quite impressive level and the prior art requires the use of 4-5 times greater amount of the adsorbent to reach the same methanol recovery from moisturized methanol acetate.

The data for methanol/water capacity ratios can provide another advantage of the adsorbents of this invention over those of the prior art. The adsorbent regeneration step releases methanol and water from the adsorbent bed and saturates the regeneration gas. The latter is chilled at the adsorber outlet; methanol and water vapors are condensed and separated from gas flow; and liquid condensate can be directed to a methanol reclaiming distillation unit. Thus, the ratio of methanol and water adsorption capacities defines the concentration of methanol in regeneration liquid. The data of Table 5 show that the adsorbents of the present invention provide a 4-5 time increase of methanol concentration in the regeneration liquid in the separation of methanol from methyl acetate and MTBE and a corresponding energy saving for methanol recycling into the process.

These results confirm that bi-cation sodium-potassium and sodium-calcium LSX exchanged forms are preferable for methyl acetate mixtures separations, while bi-cation alkaline-earth CaMgLSX and tri-cation sodium-potassium-calcium exchanged forms are the best adsorbents for methyl tert-butyl ether separation. In these applications, alkaline-earth metal content should not be less than 60% equiv.

### Example 21. (Methanol, Carboxylic Acids and Esters Separation Test)

The experimental procedure of Example 18 was repeated to compare adsorbent performance for the separation of methanol in the processes of methyl acetate and methyl methacrylate where the separation takes place in the presence of acetic and methacrylic acids. The liquid stream compositions were:
a) MeOH-0.5; MeCOOH-0.2; H₂O-0.5; MeAc-98.8% w.
b) MeOH-0.7; MeC₂H₂COOH-0.5; H₂O-0.5; MeMAcr-98.3% w.

Table 6 shows the impurities content in the purified streams at the moment of methanol breakthrough along with the adsorption capacities values that can be achieved by the applied prior art and the present invention adsorbents.

As demonstrated by Example 21, the present invention provides much higher purity of the methyl acetate and methyl methacrylate products than the prior art adsorbents. Although carboxylic acids and water significantly decrease the adsorption capacity values for methanol, the present invention's adsorbents have adsorption capacity approximately 2 times higher than the prior art adsorbents.

TABLE 6

| | | | | Dynamic |
|---|---|---|---|---|
| | Outlet Concentrations, ppm | | | Capacity for |
| Adsorbent | MeOH | RCOOH | H₂O | MeOH, % w. |

Methyl Acetate

| | | | | |
|---|---|---|---|---|
| Example 1 (NaKLSX-77) | 100 | <100 | <15 | 3.92 |
| Example 3 (NaKLSX-97) | 55 | 29 | 37 | 2.44 |
| 13X | 420 | 120 | 80 | 1.65 |

Methyl Methacrylate

| | | | | |
|---|---|---|---|---|
| Example 1 (NaKLSX-77) | 115 | <100 | <15 | 2.78 |
| Example 10 | 128 | 105 | <15 | 2.46 |
| (NaCaLSX-67) | | | | |
| 13X | 490 | 210 | 110 | 0.95 |

Accordingly, the invention provides highly efficient, reliable, and energy conserving adsorbents and adsorption technology for methanol recovery and separations from varied gas and liquid streams. The invention finds use in various adsorptive separation process, such as TSA, PSA and CSA, or displacement-purge adsorption (DPA). Thus, the invention has application to existing and new techniques in adsorbent compositions and adsorptive processes. Furthermore, utilizing the mono-, bi- or tri-cation alkali or alkaline-earth metal forms of low silica faujasite as methanol adsorbents in the present invention provides many advantages over the prior art adsorbents for methanol and oxygenate separation from gas and liquid streams.

This description of invention in specific embodiment and examples do not serve to limit the invention to the details disclosed herein. Many other variations are possible. For example, other alkali and alkaline-earth cations including lithium, barium, strontium and their combinations might be applied in the mono-, bi- and tri-cation exchanged forms LSX. The adsorbent of this invention can also be used in processes that employ fixed, moving, fluidized, simulative counter-current moving bed and so forth. Thus, the scope of the invention should be determined by the appended claims and their legal equivalents, rather than by the specific embodiments and examples given.

1.-18. (canceled)

19. An adsorbent for methanol and oxygenates separation from gas and liquid streams, said adsorbent comprising mono-, bi- or tri-cation alkali or alkaline-earth metal forms of low-silica faujasite (LSX) having a silicon to aluminum ratio from about 0.9 to about 1.15, wherein said low-silica faujasite contains cations comprising Ca or Mg cations and the content of Mg or Ca ions is 60-80% equivalent.

20. The adsorbent of claim 19 consisting essentially of a mono-cation form of low-silica faujasite (LSX) that is ion exchanged with an alkali or alkaline-earth metal.

21. The adsorbent of claim 20 wherein the mono-cation is Ca or Mg with an ion exchange degree higher than 99.2%.
